(19) United States
(12) Patent Application Publication
(10) Pub. No.: US 2016/0076752 A1
(43) Pub. Date: Mar. 17, 2016

(54) LED MODULE COMPRISING SHOCK-HAZARD PROTECTION ELEMENT

(71) Applicant: ZUMTOBEL LIGHTING GMBH, Dornbirn (AT)

(72) Inventors: Michael SPIEGEL, Dornbirn (AT); Tanja ILIC, Dornbirn (AT)

(21) Appl. No.: 14/786,892

(22) PCT Filed: Apr. 22, 2014
(86) PCT No.: PCT/EP2014/058109

§ 371 Date: Oct. 23, 2015

(30) Foreign Application Priority Data
Apr. 26, 2013 (DE) 20 2013 101 814.7

(51) Int. Cl. F21V 25/00; F21K 99/00; F21V 19/00

(52) U.S. Cl. CPC F21V 25/00; F21V 19/003; F21K 9/00; F21Y 2101/02

(57) ABSTRACT

An LED module has an LED printed circuit board having a flat surface region, an LED for generating a light, wherein the LED is arranged on the surface region of the LED printed circuit board, and a shock-hazard protection element for providing protection from touching contact being made with the surface region of the LED printed circuit board or the LED, wherein the shock-hazard protection element has a flat surface region, which is arranged so as to be oriented parallel to the flat surface region of the LED printed circuit board, wherein the shock-hazard protection element furthermore has at least one light-influencing region for optically influencing the light, which light-influencing region is configured so as to protrude from the flat surface region of the shock-hazard protection element.

The invention relates to an LED module comprising a shock-hazard protection element, an arrangement for light output comprising such an LED module, and a corresponding shock-hazard protection element as such.

In a lamp which has an LED circuit board with LEDs arranged thereon as a light emitting element, it is generally necessary to ensure that the LED circuit board is not inadvertently touched by a user of the lamp. Typically, such an LED circuit board is operated at high voltage, for example at 230 V, and corresponding touching contact with the LEDs or the current-carrying leads on the LED circuit board has a high potential for injury or damage, both for the user and also for the LEDs. Therefore, in such lamps, attempts are usually made to ensure appropriate shock-hazard protection.

DE 10 2010 041 473 A1 discloses a lamp module arrangement comprising an LED circuit board. The lamp module arrangement has a carrier element, on which the LED circuit board is arranged and held. A shock-hazard protection element is also arranged and held on the carrier element via a latching connection, extending around the LED circuit board. The shock-hazard protection element is configured as a profiled part and in principle can be detached from the carrier element by means of simple lateral displacement. Because of the profile shape, at the two longitudinal end regions of the shock-hazard protection element, an opening is additionally provided, through which in principle free access to the LED circuit board is formed. When said lamp module is used as a constituent part of a lamp, more far-reaching measures therefore have to be taken in order to achieve the desired safety.

The invention is based on the object of specifying a corresponding improved LED module. In particular, the LED module is to permit particularly reliable protection against undesired touching contact. In addition, a corresponding arrangement for light output comprising such an LED module, and a shock-hazard protection element are to be specified.

According to the invention, this object is achieved by the objects named in the independent claims. Special types of embodiment of the invention are specified in the dependent claims.

According to the invention, an LED module is provided which has an LED circuit board having a flat surface region, and at least one LED for generating a light, wherein the at least one LED is arranged on the flat surface region of the LED circuit board. Furthermore, the LED module has a shock-hazard protection element for providing protection from touching contact with the flat surface region of the LED circuit board or the at least one LED. In this case, the shock-hazard protection element has a flat surface region which is arranged so as to be oriented parallel to the flat surface region of the LED circuit board, wherein the shock-hazard protection element furthermore has at least one light-influencing region for optically influencing the light, which light-influencing region is configured so as to protrude from the flat surface region of the shock-hazard protection element.

As a result of the aforementioned shape, the shock-hazard protection element can be arranged so close to the flat surface region of the LED circuit board that inadvertently making touching contact with this surface region by a user of the LED module can practically be ruled out. In addition, by means of the aforementioned shape, the LED module can be configured with a particularly low overall height in a direction along the surface normal of the flat surface region of the LED circuit board.

The shock-hazard protection element is preferably shaped in such a way that—viewed in a projection normal to the flat surface region of the LED circuit board—it encloses the LED circuit board completely. This means that the shock-hazard protection element covers the flat surface region of the LED circuit board as far as the edge of the LED circuit board, so that in this way particularly reliable protection against touching contact is provided.

The shock-hazard protection element is preferably configured in such a way that it holds the LED circuit board by direct contact. In this way, no further component is required to hold the LED circuit board. This is advantageous in particular in terms of production technology. In addition, improved styling possibilities of the LED module are provided as a result.

The shock-hazard protection element preferably has a peripheral edge region which is shaped in such a way that it engages around an edge region of the LED circuit board. As a result of this configuration, firstly particularly reliable holding of the LED circuit board on the shock-hazard protection element is made possible and, secondly, so is particularly reliable touching contact protection.

On a side located opposite the flat surface region, the shock-hazard protection element preferably has a further flat surface region which is arranged to make flat contact with the flat surface region of the LED circuit board or is at a distance from the latter which is smaller than 2 mm, preferably smaller than 1 mm. In this way, the danger that a user will reach between the surface region of the circuit board on which the at least one LED is arranged, on the one hand, and the shock-hazard protection element, on the other hand, can be reduced.

The shock-hazard protection element furthermore preferably has at least one in particular pin-like holding element, which extends so as to project on a side of the shock-hazard protection element which is opposite the at least one light-influencing region and is arranged so as to project through at least one correspondingly shaped opening in the LED circuit board. In this way, the connection between the shock-hazard protection element and the LED circuit board can be configured particularly reliably.

The shock-hazard protection element is preferably connected to the LED circuit board in such a way that it can be separated from the LED circuit board only with the aid of a tool or by means of destruction. In this way, a particularly secure connection and suitable compliance with corresponding standards is made possible.

The shock-hazard protection element is preferably formed by an injection-molded part. In this way, the above-described form of the shock-hazard protection element can be achieved particularly suitably.

The shock-hazard protection element preferably consists of a translucent material. In this way, it is advantageously possible to achieve by production technology that the light-influencing region and the remaining shock-hazard protection element consist of only one material. Advantageously for production technology, the shock-hazard protection element preferably consists of a plastic.

Preferably, the at least one light-influencing region is configured in such a way that it forms a protrusion in the form of a truncated pyramid. As a result of this shape, particularly suitable influencing of the light, in particular distributing the light over a large spatial angle range, can be achieved.

Preferably, a hollow space or a recess, in which the at least one LED is arranged so as to project inward, is formed by the at least one light-influencing region.

Preferably, the shock-hazard protection element further has at least one stud-like projection for holding the LED module, which extends so as to project on one side of the shock-hazard protection element which is located opposite the at least one light-influencing region, and which is arranged in particular to project through at least one correspondingly shaped passage opening in the LED circuit board. By means of such a projection, the LED module is particularly well suited to be held, for example on a lamp housing or on a lamp cover.

According to a further aspect of the invention, an arrangement for light output is provided which comprises an LED module according to the invention and a light-influencing element which is arranged in such a way that it extensively influences the light generated by the at least one LED. The light-influencing element can advantageously be, for example, a cellular grid.

According to a further aspect of the invention, a shock-hazard protection element for an LED module according to the invention is provided which has a flat surface region and at least one light-influencing region which is configured so as to protrude from the flat surface region. The shock-hazard protection element further preferably has a peripheral edge region for holding an LED circuit board of the LED module. Further preferably, on a side located opposite the flat surface region, the shock-hazard protection element has a further flat surface region. For a particularly secure connection to the LED circuit board, the shock-hazard protection element can have an in particular pin-like holding element, which is arranged to project from the further flat surface region. For a particularly suitable connection to a lamp housing or the like, the shock-hazard protection element can have a stud-like projection, which is arranged to project from the further flat surface region.

The invention will be explained in more detail below by using an exemplary embodiment and with reference to the drawings, in which:

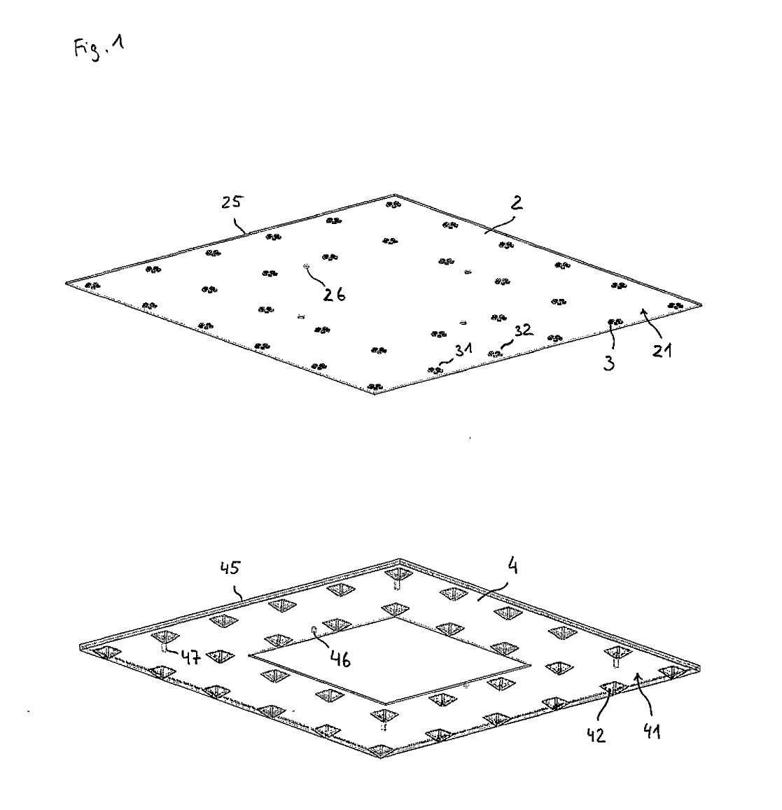

FIG. 1 shows a perspective sketch relating to an LED module according to the invention, wherein the LED circuit board and the shock-hazard protection element are illustrated separately from each other,

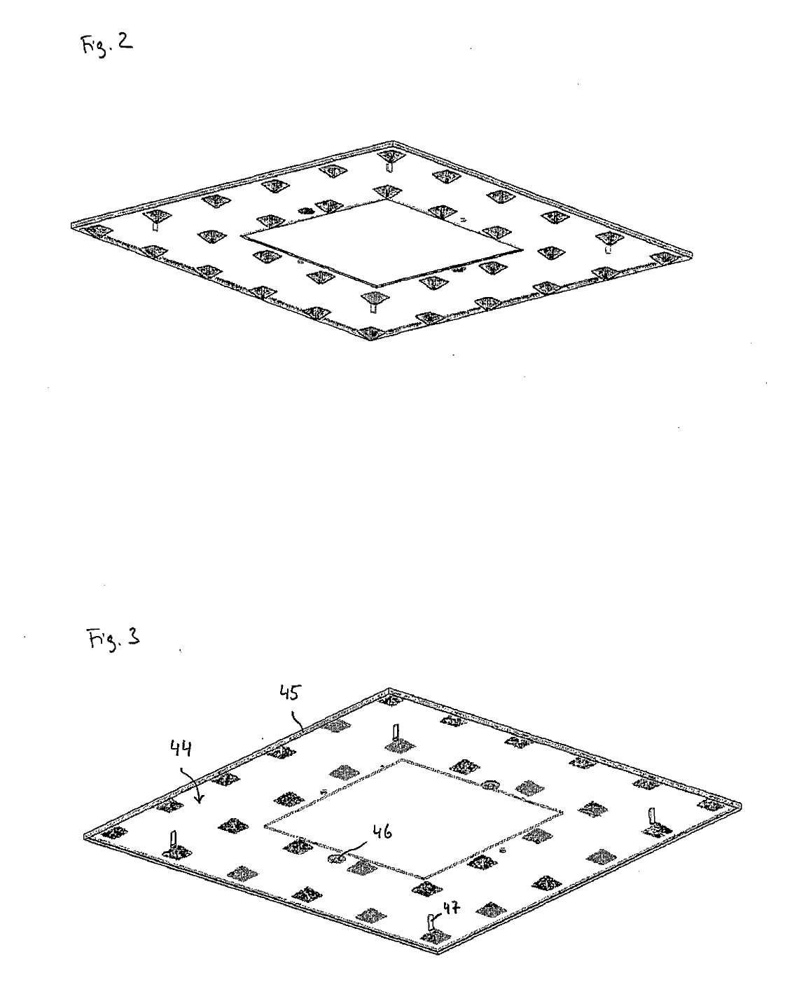

FIG. 2 shows a corresponding sketch which shows the two aforementioned components connected to each other as envisaged,

FIG. 3 shows a perspective sketch of the separated shock-hazard protection element from a different direction of view,

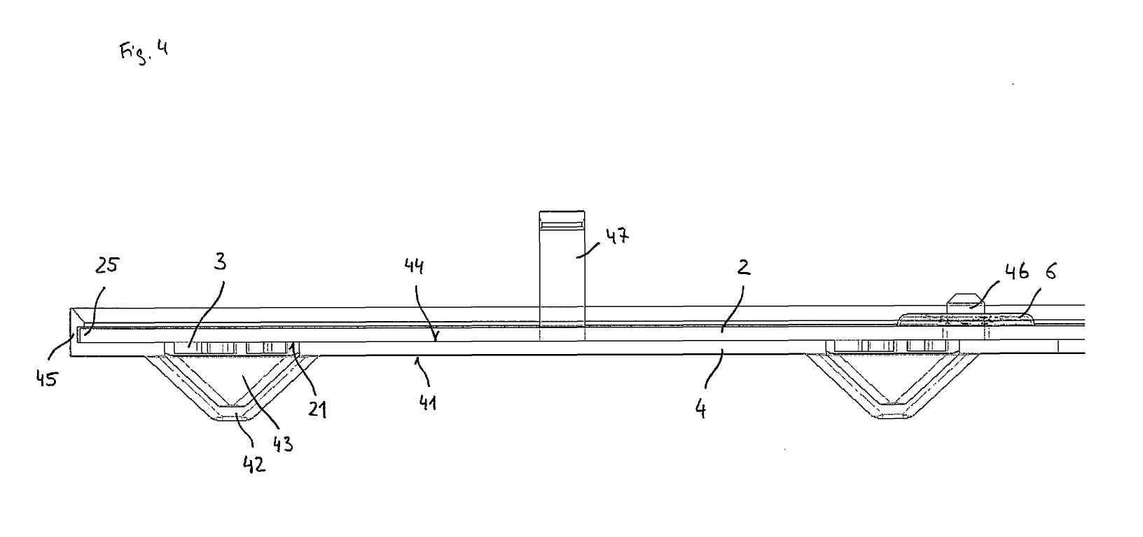

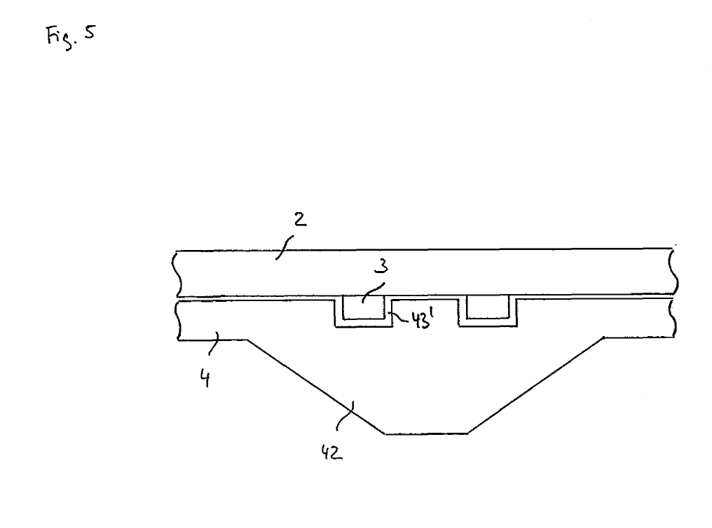

FIG. 4 shows a cross-sectional sketch which shows the two aforementioned components connected to each other as envisaged,

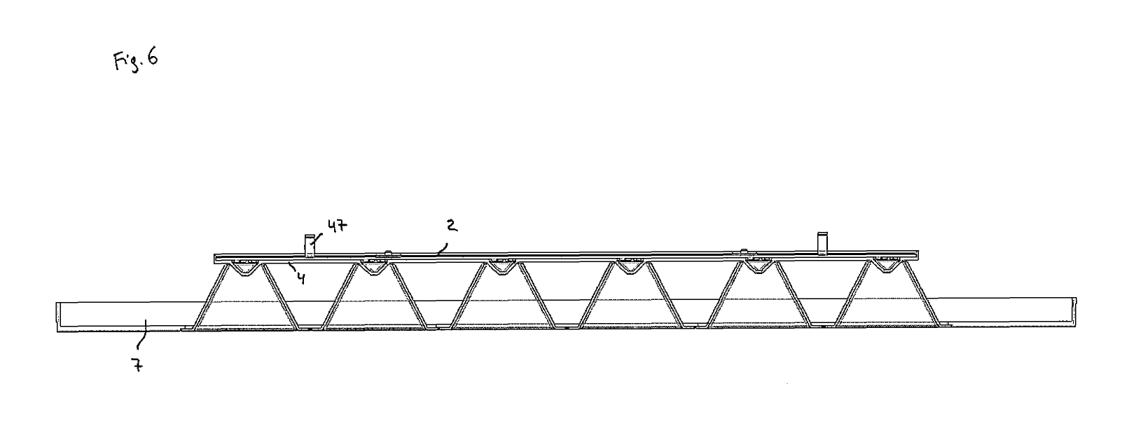

FIG. 5 shows a cross-sectional sketch relating to a variant of the light-influencing region of the shock-hazard protection element, and

FIG. 6 shows a cross-sectional sketch of an arrangement for light output which comprises an LED module according to the invention.

FIG. 1 shows a perspective sketch relating to an LED module according to the invention. The LED module comprises an LED circuit board 2 and a shock-hazard protection element 4. The shock-hazard protection element 4 is preferably composed of an electrically insulating material. The two aforementioned components 2, 4 are illustrated separately from one another in FIG. 1 so that structures can more easily be seen. FIG. 2 shows the two components 2, 4 connected to each other as envisaged.

The LED module is suitable in particular to be used as a constituent part of a lamp, in particular as a light-emitting structural unit of a lamp.

The LED circuit board 2 has a flat surface region 21. In FIG. 1 the LED circuit board 2 is shown perspectively such that the view is directed obliquely onto this flat surface region 21.

Furthermore, the LED module comprises at least one LED 3 for generating a light. Here, the at least one LED 3 is arranged on the flat surface region 21 of the LED circuit board 2.

The LED circuit board 2 is preferably configured in the form of a plate overall, so that it has two main surfaces, which are connected to each other via a narrow edge region. The flat surface region 21 is preferably formed by one of these two main surfaces.

The LED circuit board 2 has an edge region 25 which, in particular, can be formed by the above-mentioned narrow edge region. The flat surface region 21 can accordingly extend on all sides as far as the edge region 25 of the LED circuit board 2. In this sense, an edge region of the flat surface region 21 is preferably formed by the edge region 25 of the LED circuit board 2.

In the example shown, the LED module has a plurality of LEDs 3. The arrangement can be configured in such a way that at least one LED cluster or an LED group 31, 32 is formed by the LEDs 3, wherein this LED group 31, 32 comprises between two and ten LEDs 3, for example. However, provision can alternatively also be made for the LEDs 3 each to be arranged individually, that is to say with a uniform spacing from one another, or provision can be made for both individual LEDs and also LED groups to be formed. In the example shown, the LEDs 3 are arranged on the flat surface region 21 of the LED circuit board 2 in such a way that a total of thirty-two LED groups 31, 32 are formed but there are no individual LEDs.

The shock-hazard protection element 4 serves to protect against unintended touching contact with the flat surface region 21 of the LED circuit board 2 or the at least one LED 3. Protection of this type is important in particular when the LED circuit board 2 is electrically conductively connected to a power source to operate the at least one LED 3. In this case, touching contact can in particular lead to injury to the user making the touching contact or to damage to the at least one LED 3.

The shock-hazard protection element 4 has a flat surface region 41. In FIG. 1 the shock-hazard protection element 4 is shown perspectively such that the view is directed obliquely at this flat surface region 41. If, as shown in FIG. 2, the LED circuit board 2 is connected to the shock-hazard protection element 4 as envisaged, the flat surface region 41 of the shock-hazard protection element 4 is arranged so as to be oriented parallel to the flat surface region 21 of the LED circuit board 2.

This can also be seen from FIG. 4, which shows a cross section through the LED module (as a detail).

Furthermore, the shock-hazard protection element 4 has at least one light-influencing region 42 for optically influencing the light. Said light-influencing region 42 is configured in such a way that it protrudes from the flat surface region 41. In particular, the light-influencing region 42 can be configured as a primary optical element, for example as a lens. The shock-hazard protection element 4 can therefore be configured with “integrated primary optics”.

In the example shown, the shock-hazard protection element 4 has a total of thirty-two light-influencing regions 42. The configuration is preferably formulated in general terms such that, in the case of a plurality of light-influencing regions 42, each light-influencing region 42 is assigned to exactly either one individual LED 3 or one LED group 31, 32, so that that light which is emitted by one LED 3 or one LED group 31, 32 is optically influenced by the respective correspondingly associated light-influencing region 42. To this end, the configuration can in particular be such that—viewed in a projection normal to the flat surface region 21 of the LED circuit board 2—each of the light-influencing regions 42 covers the corresponding associated LED 3 or LED group 31, 32.

The shock-hazard protection element 4 is preferably shaped such that—viewed in a projection normal to the flat surface region 21 of the LED circuit board 2—it encloses the LED circuit board 2 completely. Here—advantageously in relation to the overall size of the LED module—the dimensions of the shock-hazard protection element 4 can correspond substantially to those of the LED circuit board 2. In this way, the shock-hazard protection element 4 is able to cover the flat surface region 21 of the LED circuit board 2 completely.

In the example shown, the shock-hazard protection element 4 has an opening in a central area. This configuration is suitably possible if there is no LED and no power conductor on the part of the flat surface region 21 of the LED circuit board 2 that corresponds to this opening. In the outer periphery, however, the shock-hazard protection element 4 also encloses the LED circuit board 2 in this example, as described.

The shock-hazard protection element 4 is preferably shaped in such a way that it holds the LED circuit board 2 by direct contact. In particular, provision can be made for the shock-hazard protection element 4 to be connected fixedly to the LED circuit board 2 or firmly coupled to the latter, so that the LED module forms a corresponding solid unit.

To this end, the shock-hazard protection element 4 can in particular, as designated in FIG. 4, for example, have a peripheral edge region 45 which is shaped in such a way that it engages around the edge region 25 of the LED circuit board 2. The peripheral edge region 45 of the shock hazard element 4 is preferably configured such that it engages appropriately around the edge region 25 of the LED circuit board 2 in an annularly closed form, that is to say running around uninterruptedly and on all sides. The edge region 45 of the shock-hazard protection element 4 can advantageously be configured as a latching element for this purpose, as shown by way of example in FIG. 4. As a result of this configuration of the edge regions 25, 45, it is virtually possible to avoid a user inadvertently reaching between the LED circuit board 2 and the shock-hazard protection element 4 from a side.

FIG. 3 shows a perspective sketch of the separated shock-hazard protection element 4. Here, the shock-hazard protection element 4 is shown in such a way that the view is directed toward a side which lies opposite the flat surface region 41. In FIG. 3 it is possible to see, amongst other things, the edge region 45 of the shock-hazard protection element 4 and in particular the periphery annularly closed implementation of the edge region 45.

As emerges from FIGS. 3 and FIG. 4 by way of example, on a side located opposite the flat surface region 41, the shock-hazard protection element 4 preferably has a further flat surface region 44 which is arranged to make flat contact with the flat surface region 21 of the LED circuit board 2 or is at a distance from the latter which is less than 2 mm, preferably less than 1 mm. In this way, the flat surface region 21 is, so to speak, covered completely or is possibly covered with the exception of that part which corresponds with the opening of the shock-hazard protection element 4.

As is the case in the example shown, the shock-hazard protection element 4 preferably further has at least one in particular pin-like holding element 46, which extends so as to project on a side of the shock-hazard protection element 4 which is opposite the at least one light-influencing region 42. In particular, the holding element 46 can be arranged and configured so as to protrude from the further flat surface region 44 of the shock-hazard protection element 4.

In this case, the LED circuit board 2 preferably has at least one opening 26, designated in FIG. 1, configured to correspond to the at least one holding element 46, wherein the at least one holding element 46 is arranged to project through this opening 26 in the LED circuit board 2. Furthermore, in this case, at least one locking ring 6, designated in FIG. 4, is preferably provided and is arranged to be fixed on the corresponding opposite side of the LED circuit board 2 and on the holding element 46 such that it can be released only with the aid of a tool. If a plurality of holding elements 46 with such locking rings 6 are provided, in each case a separate operation is required to release each individual locking ring 6, so that in any case a correspondingly high amount of effort is required to separate the shock-hazard protection element 4 from the LED circuit board 2.

The shock-hazard protection element 4 is preferably connected to the LED circuit board 2 in such a way that it can be separated from the LED circuit board 2 only with the aid of a tool or by means of destruction. In this way, in particular appropriate stipulations and standards can be suitably satisfied.

The shock-hazard protection element 4 is preferably formed by an injection-molded part. In particular, the shock-hazard protection element 4 can be an injection-molded part. If the shock-hazard protection element 4 is composed of a translucent material, it is possible for the light-influencing region 42 and the remainder of the shock-hazard protection element 4 to be produced from only one material. Plastic is particularly suitable for the production of the shock-hazard protection element 4.

The at least one light-influencing region 42 preferably forms a protrusion like or in the form of a truncated pyramid. This shape is particularly suitable for advantageously influencing the light.

To a first approximation, the shock-hazard protection element 4 is preferably shaped overall in the form of a plate. The light-influencing region 42 can be formed by a small-scale deviation from the plate form, as emerges by way of example from FIG. 4. In this way, as likewise emerges from FIG. 4, the at least one light-influencing region 42 can form a hollow space 43, into which the associated LED 3 or LED group 31, 32 is arranged to project.

In FIG. 5, a variant of the light-influencing region is sketched in an appropriate cross-sectional sketch, wherein the designations are used in an analogous way. According to this variant, the light-influencing region 42 is, so to speak, configured to be solid and has only a small recess 43′ for the associated LED 3 or LED group 31, 32. The recess 43′ can be configured to be shaped annularly, for example, wherein the LEDs 3 of the associated LED group 31, 32 are arranged so as to engage in this annular recess 43′.

The shock-hazard protection element 4 preferably further has at least one stud-like projection 47, which is provided and configured overall to hold the LED module, for example to hold the same in or on a lamp housing, a lamp cover or the like. This projection 47 extends so as to project on one side of the shock-hazard protection element 4 which is located opposite the at least one light-influencing region 42. In particular, the projection 47 can be arranged and configured so as to project from the further flat surface region 44 of the shock-hazard protection element 4. In this case, the LED circuit board 2 preferably has a passage opening configured so as to correspond with the projection 47 and through which the projection 47 extends.

As sketched by way of example in a further cross section in FIG. 6, provision can advantageously be made for the LED module to be connected to a light-influencing element 7 which is arranged in such a way that influences the light generated by the at least one LED 3 further, so that in this way an arrangement for light output is formed. The light-influencing element 7 can in particular be configured as a secondary optical element, for example in the form of a reflector. The light-influencing element 7 can advantageously be a cellular grid, as indicated in FIG. 6.

1. An LED module, comprising:
an LED circuit board having a flat surface region,
at least one LED for generating a light, wherein the at least one LED is arranged on the flat surface region of the LED circuit board, and
a shock-hazard protection element for protection from touching contact with the flat surface region of the LED circuit board or the at least one LED
wherein, the shock-hazard protection element has a flat surface region which is arranged so as to be oriented parallel to the flat surface region of the LED circuit board,
wherein the shock-hazard protection element furthermore has at least one light-influencing region for optically influencing the light, which light-influencing region is configured so as to protrude from the flat surface region of the shock-hazard protection element.

2. The LED module as claimed in claim 1, in which the shock-hazard protection element is shaped in such a way that viewed in a projection normal to the flat surface region of the LED circuit board it encloses the LED circuit board completely.

3. The LED module as claimed in claim 1, in which the shock-hazard protection element is configured in such a way that it holds the LED circuit board by direct contact.

4. The LED module as claimed in claim 1, in which the shock-hazard protection element has a peripheral edge region which is shaped in such a way that it engages around an edge region of the LED circuit board.

5. The LED module as claimed in claim 1, in which, on a side located opposite the flat surface region, the shock-hazard protection element has a further flat surface region which is arranged to make flat contact with the flat surface region of the LED circuit board or is at a distance from the latter which is smaller than 2 mm, preferably smaller than 1 mm.

6. The LED module as claimed in claim 1, in which the shock-hazard protection element furthermore has at least one in particular pin-like holding element, which extends so as to project on a side of the shock-hazard protection element which is opposite the at least one light-influencing region and is arranged so as to project through at least one correspondingly shaped opening in the LED circuit board.

7. The LED module as claimed in claim 1, in which the shock-hazard protection element is connected to the LED circuit board in such a way that it can be separated from the LED circuit board only with the aid of a tool or by means of destruction.

8. The LED module as claimed in in claim 1, in which the shock-hazard protection element is formed by an injection-molded part.

9. The LED module as claimed in claim 1, in which the shock-hazard protection element consists of a translucent material.

10. The LED module as claimed in claim 1, in which the shock-hazard protection element consists of a plastic.

11. The LED module as claimed in claim 1, in which the at least one light-influencing region forms a protrusion in the form of a truncated pyramid.

12. The LED module as claimed in claim 1, in which a hollow space or a recess, in which the at least one LED is arranged so as to project inward, is formed by the at least one light-influencing region.

13. The LED module as claimed in claim 1, in which he shock-hazard protection element further has at least one stud-like projection for holding the LED module, which extends so as to project on one side of the shock-hazard protection element which is located opposite the at least one light-influencing region, and which is arranged in particular to project through at least one correspondingly shaped passage opening in the LED circuit board.

14. An arrangement for light output, comprising:
an LED module as claimed in claim 1, and
a light-influencing element which is arranged in such a way that it extensively influences the light generated by the at least one LED.

15. The arrangement as claimed in claim 14, in which the light-influencing element is a cellular grid.

16. The shock-hazard protection element for an LED module as claimed in claim 1, comprising:
a flat surface region and
at least one light-influencing region, which is configured so as to protrude from the flat surface region.

17. The shock-hazard protection element as claimed in claim 16, further comprising:
a peripheral edge region for holding an LED circuit board of the LED module.

18. The shock-hazard protection element as claimed in claim 16, which, on a side located opposite the flat surface region, a further flat surface region, a pin-like holding element and/or a stud-like projection are arranged to project from the further flat surface region.
